(19) United States
(12) Patent Application Publication
(10) Pub. No.: US 2007/0083784 A1
(43) Pub. Date: Apr. 12, 2007

(54) Display device with improved brightness

(76) Inventors: Seung-kyu Park, Gyeonggi-do (KR); Jong-moo Huh, Gyeonggi-do (KR); Nam-deog Kim, Gyeonggi-do (KR); Joon-hoo Choi, Seoul (KR)

Correspondence Address: MACPHERSON KWOK CHEN & HEID LLP, 2033 GATEWAY PLACE, SUITE 400, SAN JOSE, CA, 95110, US

(21) Appl. No.: 11/525,599

(22) Filed: Sep. 22, 2006

(30) Foreign Application Priority Data
Sep. 24, 2005 (KR) 2005-0089032

(51) Int. Cl. G06F 1/32

(52) U.S. Cl. 713/321

(57) ABSTRACT

A display device that uniformly supplies a driving voltage to a display device is presented. The display device includes a plurality of power supply lines, a power supply bar electrically connected to a first end portion of the power supply lines, a power supply pad providing a driving voltage to the power supply bar, contact holes formed in the power supply bar and the power supply pad, and a bridge electrode connecting the power supply bar to the power supply pad through the contact holes.

### CROSS-REFERENCE TO RELATED APPLICATION

This application claims the benefit of Korean Patent Application No. 2005-0089032 filed on Sep. 24, 2005 in the Korean Intellectual Property Office, the disclosure of which is incorporated herein by reference.

### BACKGROUND OF THE INVENTION

1. Field of the Invention

The present invention relates to a display device, and more particularly to a display device supplying a voltage for driving the display device.

2. Description of the Related Art

Among different types of alt panel displays that are in the market, an organic light emitting diode (OLED) among has become popular due to its advantages such as low driving voltage requirement, slimness, light weight, wide viewing angle, and quick response time.

A plurality of thin film transistors (TFTs) are provided on an OLED substrate to drive the OLED. An anode electrode forming a pixel and a cathode electrode functioning as a reference voltage are on the TFTS. If voltage is applied to both electrodes, a hole and an electron combine to generate an exciton. The exciton emits light when transitioning to the ground state in a light emitting layer interposed between the two electrodes. The OLED adjusts the emitted light to display an image.

The plurality of TFTs are formed on the OLED substrate and act as a switching transistor connected to a data line and a driving transistor connected to the power supply line. Typically, there is a TFT for each pixel.

The power supply line applies a driving voltage to the pixel, thereby causing the hole and the electron to transfer into the light emitting layer. The voltage is applied through a pad made of a gate metal material. The pad is formed between the data fan out areas where data lines converge in a non-display area of the substrate. Thus, the driving voltage is supplied to the power supply line at portions where the data lines are not formed. A result of this spatial limitation is that the driving voltage may not be uniformly supplied to the power supply line.

When the driving voltage is not uniformly supplied to the power supply line, brightness of a display device is compromised. Thus, a method of applying the driving voltage without the special limitation is desirable.

### SUMMARY OF THE INVENTION

In one aspect, the present invention is a display device that includes a plurality of power supply lines, a power supply bar electrically connected to a first end portion of the power supply lines, and a power supply pad providing a driving voltage to the power supply bar, nd contact holes formed in the power supply bar and the power supply pad. A bridge electrode connects the power supply bar and the power supply pad through the contact holes.

In another aspect, the present invention is a display device including a plurality of power supply lines, a power supply pad providing a driving voltage to the power supply lines, contact holes formed in the power supply lines and the power supply pad, and a bridge electrode connecting the power supply lines and the power supply pad through the contact holes.

In yet another aspect, the present invention is a display device that includes a plurality of power supply lines, a power supply bar electrically connected to a first end portion of the power supply lines, and a power supply pad providing a driving voltage to the power supply bar. The power supply pad has a contact hole formed therein.

In yet another aspect, the present invention is a display device having a display area and a non-display area. The display device includes a plurality of power supply lines, a voltage supply unit having a first sub-part extending in a first direction in the non-display area and a plurality of second sub-parts connected to the first sub-part in the non-display area, and electrically connected with the power supply lines, contact holes formed in the voltage supply unit, and a bridge electrode connecting the power supply lines and the power supply pad through the contact holes.

### BRIEF DESCRIPTION OF THE DRAWINGS

The above and/or other aspects and advantages of the present invention will become apparent and more readily appreciated from the following description of the exemplary embodiments, taken in conjunction with the accompanying drawings, of which:

FIG. 1 is a schematic view of a display device according to a first embodiment of the present invention;

FIG. 2 is an enlarged view of an area C in FIG. 1;

FIG. 3 is a sectional view taken along the line III-III in FIG. 2;

FIG. 4 illustrates a bridge electrode and a common electrode according to the first embodiment of the present invention;

FIG. 5 is an equivalent circuit diagram of a pixel according to the first embodiment of the present invention;

FIG. 6 illustrates a bridge electrode and a common electrode according to a second embodiment of the present invention;

FIG. 7 illustrates a bridge electrode and a common electrode according to a third embodiment of the present invention; and

FIG. 8 is a schematic view of a display device according to a fourth embodiment of the present invention.

### DETAILED DESCRIPTION OF THE EMBODIMENTS

Reference will now be made in detail to exemplary embodiments of the present invention, examples of which are illustrated in the accompanying drawings, wherein like reference numerals refer to like elements throughout. The embodiments are described below in order to explain the present invention by referring to the figures.

In the following embodiments, a display device will be described as an OLED device. However, this is not a limitation of the invention and the concepts of the invention are applicable to display devices other than OLED. Any display device driven by a power supply line for supplying electric power to a light emitting layer falls within the scope of these embodiments.

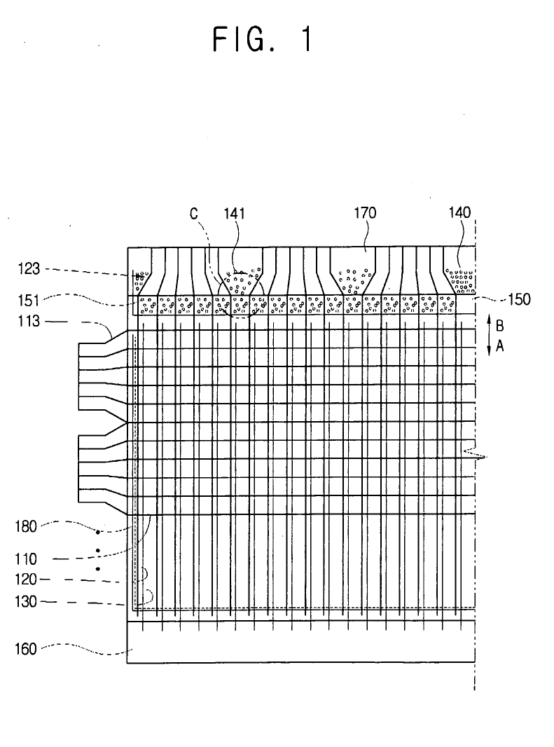

A first embodiment of the present invention will be described in reference to FIGS. 1 through 5. As shown in the drawings, a display device has a display area A that has a plurality of pixels. In the embodiment shown, the display area A is rectangular in shape, as are the pixels. The pixels are defined by gate lines 110 extending in a first direction and data lines 120 and power supply lines 130 that extend in a second direction perpendicular to the first direction.

The display device also includes a non-display area Badjacent to the display area A. A gate driving circuit (not shown) and a data driving circuit (not shown) are formed at the sides of a non-display area B. The gate driving circuit is connected to the end portions of the gate lines 110 and the data driving circuit is connected to the end portions of the data lines 120, thereby applying signals received from an outside source to the gate lines 110 and the data lines 120. The gate driving circuit and the data driving circuit may be connected to a thin film transistor (TFT) substrate by a bonding method such as a chip on glass (COG) method, a tape carrier package (TCP) method, a chip on film (COF) method, etc. The COG method entails directly mounting a driving part on the TFT substrate. The TCP method entails attaching the driving circuit to a polymer film before mounting the driving circuit on the TFT substrate. The COF method entails attaching the driving part that is mounted on a driving circuit substrate to the TFT substrate. The gate lines 110 and the data lines 120 in the display area A extend outside the display area A to be connected to the gate driving circuit and the data driving circuit through a gate pad (not shown) and a data pad (not shown). A gate fan out area 113 where the distance between the gate lines 110 changes and a data fan out area 123 where the distance between the data lines 120 changes are formed in the regions where the gate lines 110 and the data lines 120 are connected to the gate driving circuit and the data driving circuit, respectively.

A power supply bar 150, a power supply pad 140 and a voltage supply unit 160 are formed in the non-display area B. The power supply bar 150 is connected to one end portion of the power supply lines 130, the power supply pad 140 provides a driving voltage to the power supply bar 150 and the voltage supply unit 160 is connected to the other end portions of the power supply lines 130. A plurality of contact holes 141 and 151 are formed in the power supply bar 150 and the power supply pad 140, allowing the power supply bar 150 and the power supply pad 140 to electrically connect to a first bridge electrode 170.

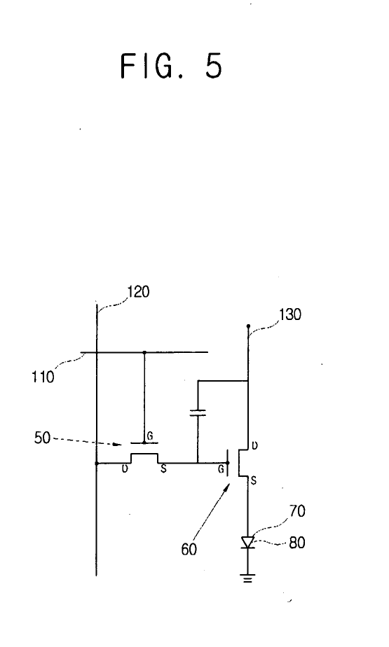

Now, an equivalent circuit of a pixel in the display device will be described with reference to FIG. 5.

As shown in FIG. 5, one pixel comprises a switching transistor 50, a driving transistor 60 and a pixel electrode 70, wherein the switching transistor 50 is electrically connected to one of the gate lines 110 and one of the data lines 120, the driving transistor 60 is electrically connected to a source electrode S of the switching transistor 50 and one of the power supply lines 130, and the pixel electrode 70 is physically and electrically connected to the driving transistor 60. The pixel includes a light emitting layer 80 emitting light in response to voltage applied by the pixel electrode 70.

The gate lines 110 are disposed parallel to each other and perpendicularly to the data lines 120 and the power supply lines 130. The gate lines 110, the data lines 120, and the power supply lines 130 define a pixel. A gate metal layer comprises the gate lines 110 and gate electrodes G of the respective transistors 50 and 60 and may be single-layer or multi-layer. The gate lines 110 apply a gate on/off voltage to the switching transistor 50 connected to the gate lines 110.

A data metal layer comprises the data lines 120 extending perpendicularly to the gate lines 110, drain electrodes D of the respective transistors 50 and 60 and the source electrode S and is insulated from the gate metal layer. The data lines 120 apply a data voltage to the switching transistor 50.

The power supply lines 130 are disposed parallel to the data lines 120 and cross the gate lines 110 to form the pixels in a matrix array. The power supply lines 130 are generally formed on the same layer as the data lines 120 of a data metal layer. As shown in the drawing, the power supply lines 130 are connected to the power supply bar 150 at one end portion and to the voltage supply unit 160 at the other end portion. The power supply lines 130 supply a driving voltage of a certain level to the driving transistor 60.

One of the power supply lines 130 is disposed in every single pixel but a power supply line may be shared by two pixels. In other words, two pixels that are disposed adjacent to a single power supply line 130 may be supplied with the driving voltage through the single power supply line 130. When two pixels share a power supply line, the number of power supply lines 130 decreases, simplifying the manufacturing process. Also, the size of the area where voltage is applied decreases, and thus an electromagnetic interference becomes less of a problem.

The switching transistor 50 has a gate electrode G protruding in a portion of the gate line 110, the drain electrode D coupled to the data line 120, the source electrode S separated from the drain electrode D, and a semiconductor layer (not shown) formed between the drain electrode D and the source electrode S. The gate-on voltage applied to the gate line 110 is transmitted to the gate electrode G of the switching transistor 50. When the gate electrode G is turned on, the data voltage transmitted by the data line 120 is applied to the source electrode S through the drain electrode D.

The driving transistor 60 adjusts an electric current between the drain electrode D and the source electrode S according to the data voltage provided to the gate electrode G. Voltage applied to the pixel electrode 70 through the source electrode S corresponds to a difference between the data voltage provided from the gate electrode G and the driving voltage provided from the drain electrode D.

A passivation layer (not shown) is formed between the drain electrode D of the driving transistor 60 and the pixel electrode 70, and a contact hole (not shown) is formed in the passivation layer to electrically connect the drain electrode D to the pixel electrode. The pixel electrode 70 functions as an anode to provide holes to the light emitting layer 80.

An organic insulating layer made of an organic material is formed between the pixels. The organic insulating layer prevents short-circuiting between neighboring pixel electrodes 70 and separates the pixels from each other.

The common electrode 180 is disposed on a front surface of the display area A. An electric current in the light emitting layer 80 escapes through the common electrode 180.

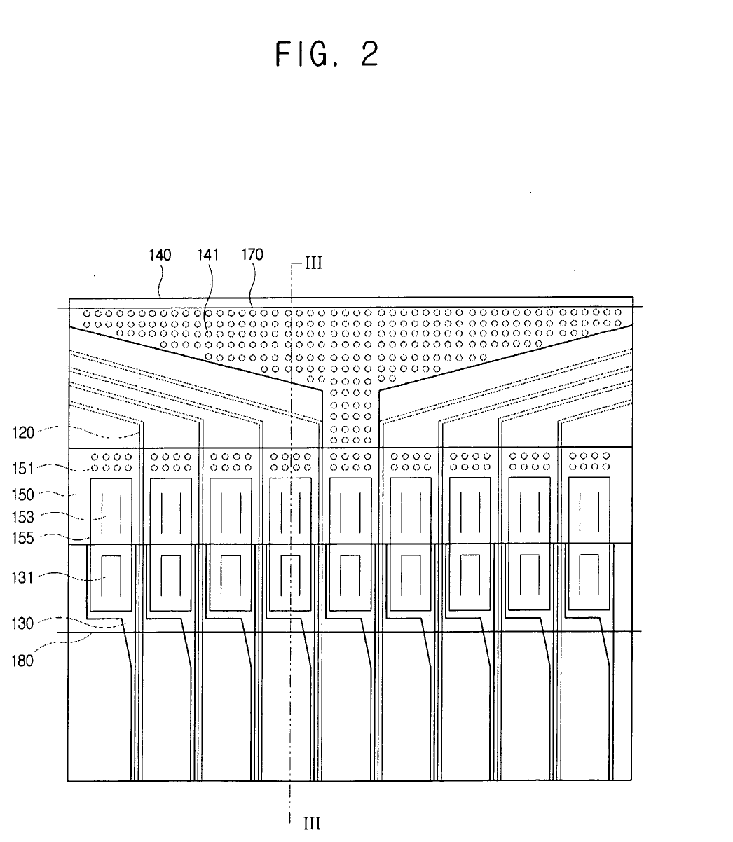

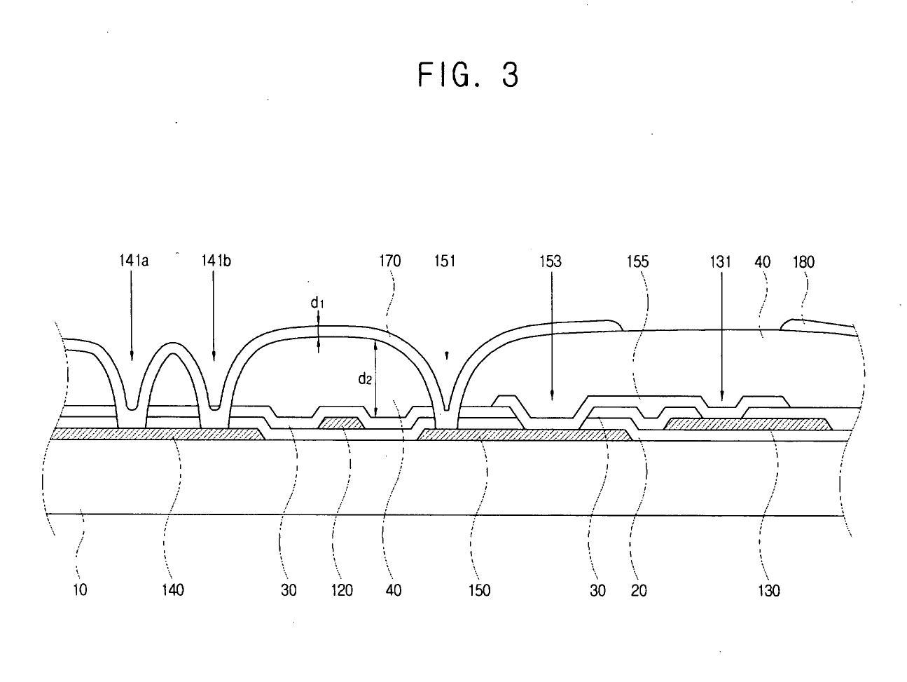

Hereinafter, an area C in FIG. 1 will be described with reference to FIGS. 2 and 3.

As shown in FIG. 2, the data lines 120 and the power supply lines 130 extend parallel to each other, wherein the data lines 120 form the data fan out area 123.

The common electrode 180 is formed in the entire front surface of the display area A of the display device.

The power supply lines 130 are electrically connected to the power supply bar 150 through a second bridge electrode 155 in the non-display area. In order to connect the power supply lines 130 and the power supply bar 150 which are disposed in different metal layers, the power supply lines 130 and the power supply bar 150 have contact holes 131 and 153, respectively. The second bridge electrode 155 connecting the power supply lines 130 and the power supply bar 150 comprises a transparent conductive material such as indium tin oxide (ITO) or indium tin zinc (IZO) and is generally formed on the same layer as the pixel electrode 70.

The power supply bar 150 electrically connected with the power supply lines 130 is electrically connected to the power supply pad 140 as well. Generally, the power supply bar 150 and the power supply pad 140 contain a gate metal material and are formed on the same layer in a single body. In other words, the power supply bar 150 and the power supply pad 140 are formed at the same time when the gate metal layer is patterned. The driving voltage is supplied to the power supply lines 130 through the power supply bar 150 extending in the first direction in the non-display area B, and the power supply pad 140 is connected to the power supply bar 150 in the non-display area B. As shown, the power supply pad 140 has a funnel shape with one end wider than the other.

Conventionally, in this case, the power supply bar 150 and the power supply pad 140 are connected only in a narrow space between the data fan-out areas 123. That is, the driving voltage may be transmitted to the power supply bar 150 only through the narrow space. This configuration can be disadvantageous, for example because it causes an electrical bottleneck situation, preventing a uniform and quick transmission of the driving voltage to the power supply lines 130 disposed across a wide area.

Attempts have been made to reduce the high resistance caused by the bottleneck by increasing the thickness of the driving voltage bar 150. When this is done, however, the power supply bar 150 of the gate metal layer overlaps with a larger portion of the data lines 120 of the data metal layer. This increased overlap is problematic in that it increases the possibility of generating a short circuit between the power supply bar 150 and the data lines 120 and generates a parasitic capacity between the metal layers. As the parasitic capacity increases, an image signal applied to the data lines 120 may become distorted and deteriorated.

The power supply pad 140 and the power supply bar 150 according to the present embodiment are electrically connected to each other through the plurality of contact holes 141 and 151 and the first bridge electrode 170. That is, power supply pad 140 and the power supply bar 150 are connected with each other not only physically but also through the first bridge electrode 170, thereby increasing the area for transmitting the driving voltage. The increased area for voltage transmission allows the driving voltage to be transmitted quickly, decreasing the amount of electric current caused by the high resistance. Also, the bottleneck created by the space limitation decreases, preventing any lifting of the light emitting layer that is caused by the heat generated from high electric current. Ultimately, the uniform driving voltage improves the entire brightness of the display device.

There are multiple contact holes 141 and 151. The more contact holes 141, 151 there are, the more efficient is the transmission of driving voltage between the power supply pad 140 and the power supply bar 150.

The first bridge electrode 170 according to the present embodiment is formed on the same layer as the common electrode 180 in the display area A. That is, the first bridge electrode 170 is made of the same material as the common electrode 180 and is separated from the common electrode 180 by a distance of about several micrometers (μm) when the common electrode 180 is patterned. The first bridge electrode 170 may be made of at least one of aluminum (Al), silver (Ag), calcium (Ca) and barium (Ba), for example, and could be a single layer or multiple layers.

Although not shown, the first bridge electrode 170 is also formed near the voltage supply unit 160 connected to the other end of the power supply lines 130. The first bridge electrode 170 at the power supply bar 150 and the bridge electrode at the voltage supply unit 160 may be formed approximately symmetrically with respect to the display area A. However, the shape of the voltage supply unit 160 may be different from the shape of the power supply bar 150 because the voltage supply unit 160 does not share a space with the data fan out area 123 in the non-display area B. As shown in FIG. 1, the voltage supply unit 160 extends in the first direction like the gate lines 110. In some embodiments, the voltage supply unit 160 may be divided into a plurality of areas. If the shape of the voltage supply unit 160 changes, the shape of the first bridge electrode 170 may be adjusted to substantially match the shape of the voltage supply unit 160. The matching shapes make the resistance uniform.

Further, the first bridge electrode 170 may include a pattern that matches the pattern on each of the power supply lines 130. The effect is application of the driving voltage to each of the power supply lines 130.

FIG. 3 is a sectional view taken along the line III-III in FIG. 2. The power supply pad 140 and the power supply bar 150, which are made from the gate metal layer, are formed on an insulating substrate 10.

A gate insulating layer 20 made of silicon nitride (SiNx) or the like covers the gate metal layer. The gate insulating layer 20 electrically insulates the gate metal layer from the data metal layer.

The data lines 120 that extend between the power supply pad 140 and the power supply bar 150 as well as the power supply lines 130 of a data metal material are formed from the same layer as the data lines 120.

A passivation layer 30 is formed on the gate insulating layer 20 and the data metal layer. The passivation layer 30 includes silicon nitride (SiNx) and/or an organic material. The passivation layer 30 has contact holes 141a and 141b extending to the power supply pad 140, the contact holes 151 and 153 extending to the power supply bar 150, and the contact hole 131 extending to the power supply line 130.

The power supply bar 150 and the power supply lines 130 are connected to the second bridge electrodes 155 through the contact holes 153 and 131. The driving voltage is transmitted from the power supply bar 150 to the power supply lines 130 through the second bridge electrode 155.

An organic insulating layer 40 is disposed on the passivation layer 30 and is thicker than other insulating layers or the passivation layer 30. The organic insulating layer 40 has lower resistance than an inorganic insulating layer. Preferably, the thickness d2 of the organic insulating layer 40 is in a range of about 1 μm to 7 μm to prevent short-circuiting between the gate metal layer and the data metal layer and also to prevent generation of parasitic capacity between the metal layers. However, the thickness d2 may be adjusted depending on the size of the display device and characteristics of the organic insulating layer 40.

The organic insulating layer 40 has the contact holes 141a and 141b extending to the power supply pad 140 and the contact hole 151 extending to the power supply bar 150, These contact holes 141a, 141b, 151 are the same contact holes that extend through the passivation layer 30.

The first bridge electrode 170 and the common electrode 180 are disposed on the organic insulating layer 40 at the same level. The common electrode 180 typically contains an opaque material such as aluminum (Al), silver (Ag), calcium (Ca) or barium (Ba). As described above, the first bridge electrode 170 may be formed as at least two metal layers. Generally, the thickness of the common electrode 180, when it is a single layer, is in the range of about 5000 Å to 7000 Å. However, this range may be varied when using multiple layers. For example, disposing metal having low resistance in the lower part and metal having excellent stability in the upper part may have a stabilizing effect on the first bridge electrode 170. Thus, in this case, the thickness d1 of the first bridge electrode 170 is preferably in the range of about 0.5 μm to 1 μm. The first bridge electrode 170 is separated from the common electrode 180 by a distance that is in the range of several μm to several mm.

The common electrode 180 contains a metal having low work function to effectively inject electrons into the light emitting layer 80. The common electrode 180 may contain a transparent conductive material, such as the material in the pixel electrode 70. In this case, light may exit through a surface that is opposite to the insulating substrate 10 unlike in the present embodiment where light exits through the insulating substrate 10.

The display device may further include a passivation layer (not shown) to protect the first bridge electrode 170 and the common electrode 180.

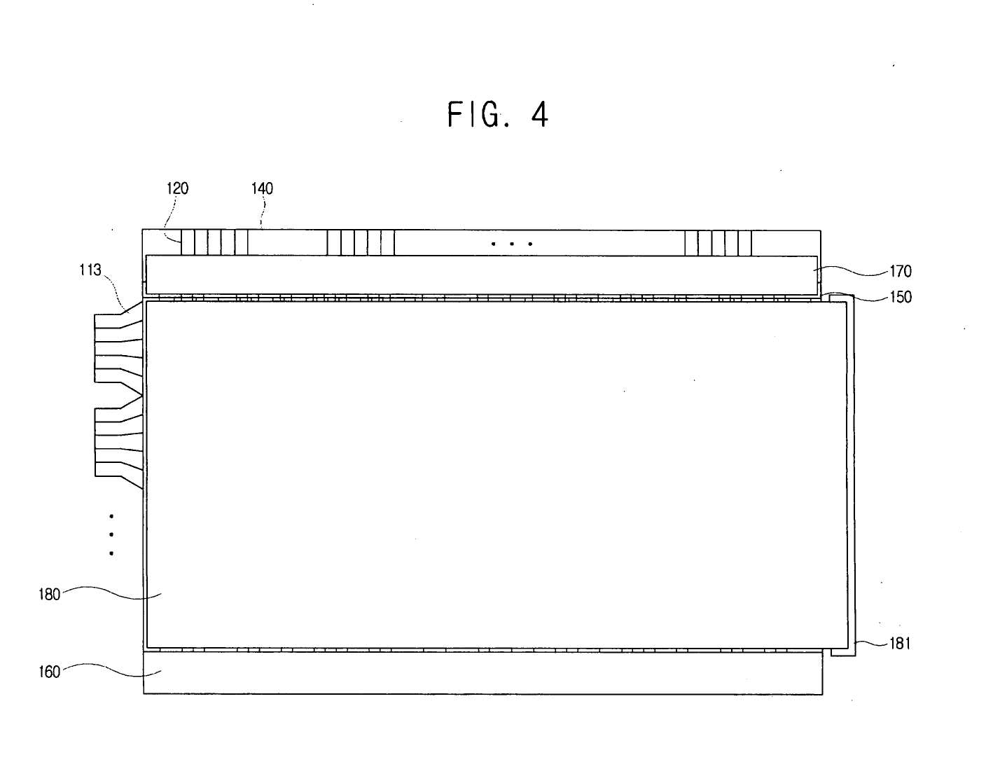

FIG. 4 is a plan view of the display device showing the bridge electrode and the common electrode according to the present embodiment. As shown in FIG. 4, the first bridge electrode 170 extends in the direction of the gate lines 110 and are separated from the common electrode 180 by a predetermined distance on the same layer.

The lines 110, 120 and 130, the power supply pad 140, and the power supply bar 150 are formed on the insulating substrate 10, and the first bridge electrode 170 is formed from the same material as the common electrode 180. As described above, the voltage supply unit 160 is formed substantially symmetrically to the first bridge electrode 170 and the common electrode 180 is disposed therebetween.

A first common voltage applying pad 181 is disposed on the right side of the insulating substrate 10 and applies a common voltage to the common electrode 180. The first common voltage applying pad 181 is typically made of the gate metal layer and is formed in the non-display area separately from the power supply pad 140 when the gate metal layer is patterned. The first common voltage applying pad 181 is connected to the common electrode 180 through a plurality of contacting areas and is independently supplied the common voltage from an external source.

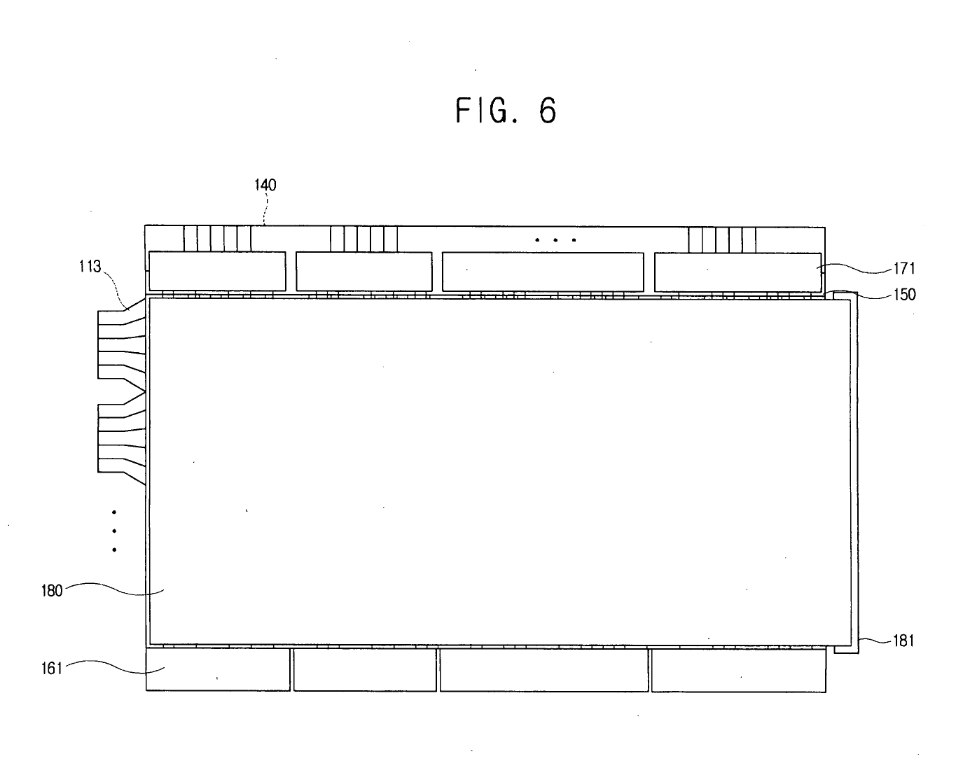

FIG. 6 is a plan view of a display device according to a second embodiment of the present invention. A first bridge electrode 171 and a voltage supply unit 161 in FIG. 6 are different from the first bridge electrode 170 and the voltage supply unit 160 of the embodiment in FIG. 4.

The first bridge electrode 171 is divided into a plurality of sub-parts that are separated by a predetermined distance. Power supply lines 130, which are arranged adjacently to data lines 120, connect to a data driving circuit and to a sub-part of the first bridge electrode 171. That is, each sub-part of the first bridge electrode 171 is separated between the data fan out areas 123 at the predetermined spacing distance. This configuration is made while the common electrode 180 and the first bridge electrode 171 are patterned in various ways. Thus, the common electrode 180 and the first bridge electrode 171 may have any of various shapes depending on how they are patterned.

A driving voltage supply unit 161 according to the second embodiment of the present embodiment has the same configuration as the first bridge electrode 171 and is disposed substantially symmetrically with the first bridge electrode 171 so as to equalize the degree of resistance generated when applying a driving voltage. In other words, the driving voltage supply unit 161 is divided into a plurality of subparts that are separated by a predetermined distance.

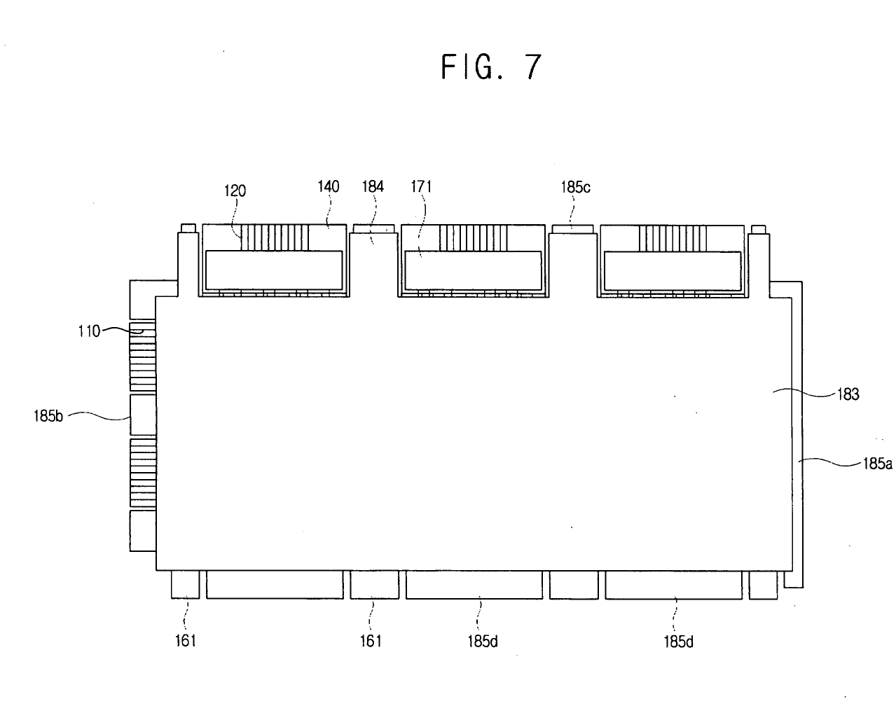

FIG. 7 is a plan view of a display device showing a bridge electrode and a common electrode according to a third embodiment of the present invention. As shown in FIG. 7, common voltage applying pads 185a, 185b, 185c and 185d are disposed along each side of the rectangular display area A and apply a common voltage at the four sides of the display area.

As the display device has become large, a gate driving part and a data driving part may be disposed as multiple parts at opposite ends of the respective gate and data lines to provide a gate voltage and a data voltage. Likewise, a common voltage applying pad 185 applying a common voltage may be provided as multiple sub-parts.

A second common voltage applying pad 185a disposed on the right side of the display area has the same shape as the first common voltage applying pad 181 shown in FIGS. 4 and 6 and applies the common voltage to the common electrode 183 from the right side of the display area, the “right side” referring to the orientation in FIG. 7.

A third common voltage applying pad 185b disposed on the left side of the display area is connected to the common electrode 183. The “left side” refers to the orientation in FIG. 7. The common electrode 183 expands to a gate fan out area 113 of the gate lines 110. The third common voltage applying pad 185b disposed between the gate fan out areas 113 applies the common voltage to the common electrode 183 from the left side of the display area. That is, a signal applied to the display area from the left side of the display area is the common voltage and the gate voltage. The third common voltage applying pad 185b is formed of the same gate metal layer as the gate lines 110 and, in this case, is separated from the gate lines 110 so as not to be short-circuited with the gate lines 110.

If the gate fan out area 113 is formed on the right side of the display area and applied with the gate voltage, the second common voltage applying pad 185a would have the same shape as the third common voltage applying pad 185b. A protrusion area 184 protrudes from the common electrode 183 and is formed in the non-display area where the data fan out area 123 is disposed. The protrusion area 184 is formed integrally with the common electrode 183 and connected to a fourth common voltage applying pad 185c. That is, the common electrode 183 is connected to the fourth common voltage applying pad 185c applying the common voltage, thus transmitting common voltage to the upper part of the display area as well, the “upper part” referring to FIG. 7. Also, the fourth common voltage applying pad 185c is disposed adjacently to a driving voltage pad 140 between the data fan out areas 123. The fourth common voltage applying pad 185c is separated from the data lines 120 and the driving voltage pad 140 so as to avoid any short-circuiting.

The data voltage, the common voltage and the driving voltage are supplied to the display area.

A fifth common voltage applying pad 185d is formed in a lower part of the display area corresponding to the fourth common voltage applying pad 185c. The “lower part” refers to the orientation in FIG. 7. A voltage supply unit 161 is next to the fifth common voltage applying pad 185d and the voltage supply unit 161 and the fifth common voltage applying pad 185d are disposed in an alternating manner. The ratio of the sizes between the fifth common voltage applying pad 185d and the voltage supply unit 161 is constant, but may be variable depending on the size of the display apparatus or the amount of voltage to be applied. As used herein, the “common electrode 183” does not include the protrusion area 184 in the upper part of the display area.

The data voltage as well as the gate voltage may be provided from the two ends of the data lines 120. In this case, the fifth common voltage applying pad 185d has a similar shape to the fourth common voltage applying pad 185c since the data fan out area 123 is formed in the lower part of the display area as well as the upper part.

As described, the shapes of the common voltage applying pad 185 and the common electrode 183 depend on various factors of the display device, such as the configuration and position of the gate driving part and the data driving part or the required voltage.

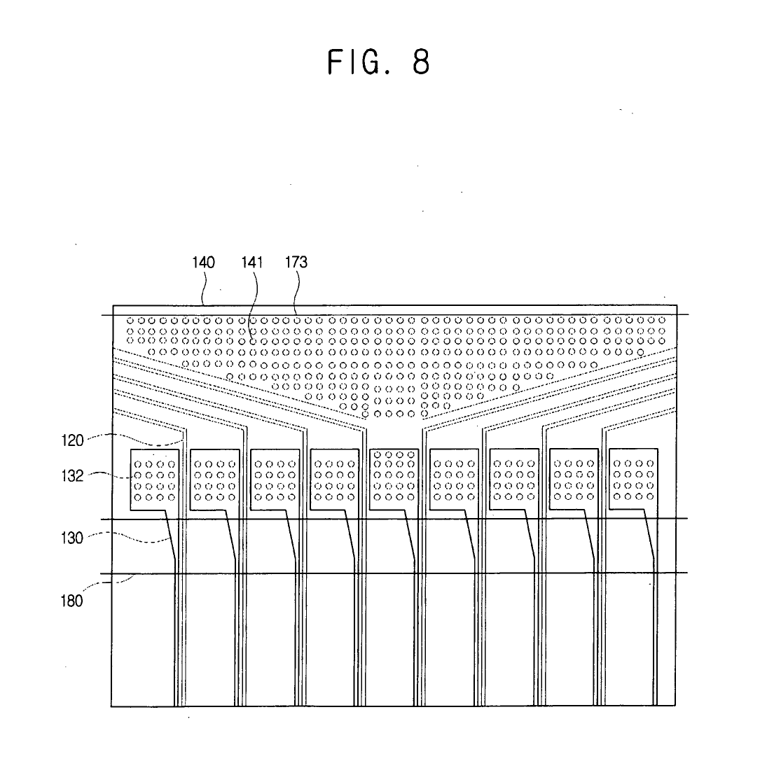

FIG. 8 is a schematic view of a display device according to a fourth embodiment of the present invention. More specifically, FIG. 8 is an enlarged view of the part of the fourth embodiment that is a counterpart of the area C of FIG. 1. Redundant descriptions will be omitted below.

The display device according to the fourth embodiment has a similar configuration to the first embodiment except that the display device does not have the power supply bar 150. More specifically, the power supply pad 140 is directly connected to the power supply line 130 in the fourth embodiment, unlike in the first embodiment where the power supply pad 140 is indirectly connected to the power supply line 130 through the power supply bar 150.

A first bridge electrode 173 connects the power supply line 130 and the power supply pad 140 through a contact hole 132 formed on the power supply line 130 and a contact hole 141 formed on the power supply pad 140.

The power supply pad 140 is directly connected to the power supply line 130 without using the power supply bar 150, thereby improving the transmission speed of driving voltage and effectively reducing a metal resistance.

Also, where the power supply bar 150 overlaps the power supply line 130, there is a greater possibility of generating a short circuit between metal layers. The fourth embodiment, where there is no power supply bar, lowers the chance of the power supply bar short-circuiting with the power supply line 130 and clears parasitic capacity between the metal layers. Further, eliminating the power supply bar simplifies the manufacturing process for the display apparatus, thereby effectively decreasing a defect rate.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A display device comprising:
a plurality of power supply lines;
a power supply bar electrically connected to a first end portion of the power supply lines;
a power supply pad providing a driving voltage to the power supply bar;
contact holes formed in the power supply bar and the power supply pad; and
a bridge electrode connecting the power supply bar and the power supply pad through the contact holes.

2. The display device according to claim 1, wherein the power supply bar and the power supply pad are integrated.

3. The display device according to claim 1, further comprising a voltage supply unit connected to a second end portion of the power supply lines.

4. The display device according to claim 3, wherein the voltage supply unit and the bridge electrode are disposed symmetrically with respect to an axis that extends the same direction as the voltage supply unit between the voltage supply unit and the bridge electrode.

5. The display device according to claim 1, wherein the bridge electrode comprises at least two metal layers.

6. The display device according to claim 1, wherein the bridge electrode comprises at least one of aluminum (Al) silver (Ag), calcium (Ca) and barium (Ba).

7. The display device according to claim 1, wherein the thickness of the bridge electrode is in a range of about 0.5 μm to about 1 μm.

8. The display device according to claim 1, further comprising:
a gate line;
a data line extending perpendicularly to the gate line;
a switching transistor disposed at the intersection of the gate line and the data line;
a driving transistor connected to the power supply line and a pixel electrode;
a light emitting layer formed on the pixel electrode; and
a common electrode formed on the light emitting layer.

9. The display device according to claim 8, wherein the bridge electrode is formed from the same layer as the common electrode.

10. The display device according to claim 8, further comprising a common voltage applying pad applying a common voltage to the common electrode.

11. The display device according to claim 10, wherein the common voltage applying pad is located at least one side of a display area of the display device.

12. The display device according to claim 11, wherein the common electrode comprises a protrusion area protruding from the display area toward a non-display area and the bridge electrode is formed between the protrusion areas.

13. The display device according to claim 8, wherein the data line is disposed at least on a portion between the power supply pad and the power supply bar, and wherein the display device further comprises an organic insulating layer disposed between the data line and the common electrode.

14. The display device according to claim 13, wherein the thickness of the organic insulating layer is in a range of about 1 μm to about 7 μm.

15. A display device comprising:
a plurality of power supply lines;
a power supply pad providing a driving voltage to the power supply lines;
contact holes formed in the power supply lines and the power supply pad; and
a bridge electrode connecting the power supply lines and the power supply pad through the contact holes.

16. The display device according to claim 15, wherein the bridge electrode comprises at least two metal layers.

17. The display device according to claim 15, wherein the thickness of the bridge electrode is in a range of about 0.5 μm to about 1 μm.

18. The display device according to claim 15, further comprising:
a gate line;
a data line extending perpendicularly to the gate line;
a switching transistor disposed at the intersection of the gate line and the data line;
a driving transistor connected to the power supply line;
a pixel electrode connected to the driving transistor;
a light emitting layer formed on the pixel electrode; and
a common electrode formed on the light emitting layer.

19. The display device according to claim 18, wherein the bridge electrode is formed from the same layer as the common electrode.

20. The display device according to claim 18, wherein the data line is disposed at least on a portion between the power supply pad and the power supply bar, and wherein the display device further comprises an organic insulating layer disposed between the data line and the common electrode.

21. A display device comprising:
a plurality of power supply lines;
a power supply bar electrically connected to a first end portion of the power supply lines; and
a power supply pad providing a driving voltage to the power supply bar, the power supply pad having a contact hole formed therein.

22. The display device according to claim 21, further comprising a bridge electrode connecting the power supply bar and the power supply pad through the contact hole.

23. The display device according to claim 21, wherein the contact hole is one of a plurality of contact holes.

24. The display device according to claim 22, wherein the bridge electrode comprises at least one of aluminum (Al), silver (Ag), calcium (Ca) and barium (Ba).

25. The display device according to claim 22, further comprising,
a gate line;
a data line extending perpendicularly to the gate line;
a switching transistor disposed at the intersection of the gate line and the data line;
a driving transistor connected to the power supply line and a pixel electrode;
a light emitting layer formed on the pixel electrode; and
a common electrode formed on the light emitting layer,
wherein the bridge electrode is formed from the same layer as the common electrode.

26. The display device according to claim 25, wherein the data line is disposed at least on a portion between the power supply pad and the power supply bar, and wherein the display device further comprises an organic insulating layer disposed between the data line and the common electrode.

27. The display device according to claim 21, further comprising a voltage supply unit connected to a second end portion of the power supply lines.

28. The display device according to claim 27, wherein the voltage supply unit and the bridge electrode are disposed symmetrically with respect to an axis that extends the same direction as the voltage supply unit between the voltage supply unit and the bridge electrode.

29. A display device having a display area and a non-display area, the device comprising:
a plurality of power supply lines;
a voltage supply unit having a first sub-part extending in a first direction in the non-display area and a plurality of second sub-parts connected to the first sub-part in the non-display area and electrically connected to the power supply lines;
contact holes formed in the voltage supply unit; and
a bridge electrode connecting the power supply lines and the power supply pad through the contact holes.

30. The display device according to claim 29, further comprising,
a gate line;
a data line extending perpendicularly to the gate line;
a switching transistor disposed at the intersection of the gate line and the data line;
a driving transistor connected to the power supply line and a pixel electrode;
a light emitting layer formed on the pixel electrode; and
a common electrode formed on the light emitting layer,
wherein the bridge electrode is formed from the same layer as the common electrode.

31. The display device according to claim 30, wherein the voltage supply unit is formed from the same layer as the gate line.

32. The display device according to claim 29, wherein the second sub-parts are separated from each other at a regular predetermined distance.
